(19) United States
(12) Patent Application Publication
(10) Pub. No.: US 2009/0013074 A1
(43) Pub. Date: Jan. 8, 2009

(54) SYSTEM AND METHOD FOR DISTRIBUTED NETWORK MONITORING FOR STEGANOGRAPHIC MESSAGES

(76) Inventor: William H. Rice, Austin, TX (US)

Correspondence Address: HULSEY IP INTELLECTUAL PROPERTY LAWYERS, P.C., 919 Congress Avenue, Suite 919, AUSTIN, TX, 78701, US

(21) Appl. No.: 12/211,711

(22) Filed: Sep. 16, 2008

Related U.S. Application Data
(63) Continuation of application No. 10/314,853, filed on Dec. 9, 2002.

(51) Int. Cl. G06F 15/173; H04L 9/32; G06K 9/00; G06F 17/30; G06F 7/04

(52) U.S. Cl. 709/224; 726/2

(57) ABSTRACT

This invention relates to distributed monitoring of networks for steganographically encrypted or encoded messages. Terrorists or criminal groups may use stenography to encode or hide messages in image data or other encrypted data. Law enforcement agencies seek to monitor the distributed networks for the hidden information. However, the size of the Internet exceeds the capacity of law enforcement resources. A method and system are described that use various computational devices distributed about the network to individually monitor network locations. Suspect data is documented on a set of servers. These servers then alert analysts to the presence of suspicious data. In one exemplary embodiment, a common interpreted programming language is used to program a set of instructions that may be performed by various devices distributed about the Internet to monitor network locations for encoded or hidden communications.

### RELATED APPLICATIONS

This is a continuation of U.S. patent application Ser. No. 10/314,853 filed Dec. 9, 2002 entitled, “SYSTEM AND METHOD FOR DISTRIBUTED NETWORK MONITORING FOR STEGANOGRAPHIC MESSAGES,” which is incorporated herein by reference as though set forth in full.

### TECHNICAL FIELD OF THE INVENTION

This invention in general relates to monitoring network locations for steganographic messages. More specifically, the invention relates to distributed monitoring of network locations for messages steganographically hidden in various file formats.

### BACKGROUND OF THE INVENTION

Steganography is the art concealing messages within data. Historically, steganographic techniques included hiding in messages within a body of writing. If the method of hiding the text was known, the text message could be revealed or decoded. More modern examples include hiding image data or messages within other images. In this manner, a seemingly mundane image could be carrying secret information.

FIG. 1 depicts the steganographic process in which a data 12 is used or combined with the message data 14 to form an integrated data 16. The integrated data, upon observation, may have many common characteristics with the data 12 such as aesthetic characteristics, format characteristics, and quality characteristics. For this reason, the presence of message data 14 may not be obvious. However, if a method of decoding is known, the message data 14 may be recovered. This steganographic process may be useful in hiding image data within other images, sound messages within sound files, image data within sound files, and data files within other encrypted data files, among others. Many examples in which data may be hidden within seemingly innocuous data may be envisioned.

With the advent of computers, various methods for creating steganographic files have been developed. Moreover, digital steganographic messages may be easily transferred across the more recently developed digital networks. Seemingly unimportant network traffic may carry hidden messages.

In February of 2001, USA Today reported that terrorists may be hiding messages and posting instructions for terrorist activities in locations such as sports chat rooms, pornographic bulletin boards and other popular websites. Reportedly, the various extremists posted encrypted or scrambled photographs and messages on these popular websites and used them to plan and coordinate terrorist activates against the United States and its allies. For this reason, U.S. law enforcement officials and defense agencies are attempting to monitor the Internet for these hidden subversive communications.

However, the size and quantity of network traffic and network locations make this task daunting. Available computation cycles and network capacity of these government agencies limits their ability to gather an adequate amount of information to ensure discovery of hidden messages.

As such, typical law enforcement efforts suffer from deficiencies in bandwidth and the availability of computational cycles. Many other problems and disadvantages of the prior art will become apparent to one skilled in the art after comparing such prior art with the present invention as described herein.

### SUMMARY OF THE INVENTION

Aspects of the invention may be found in a method for detecting data on a network. The method includes searching locations on the network for data, testing that data to determine if it likely contains hidden data and alerting an analyst. The method may also include retrieving at least one parameter associated with the searching period. For example, the parameter could be a location on the network or a range of locations to be searched. The method may further include retrieving programming instructions associated with the method from a server. These programming instructions may be programmed in an interpretable programming language such as JAVA, or they may be an executable file. The method may also include retrieving parameters associated with the testing methods of indicator thresholds and the location of an analyst, among others.

Further aspects of the invention may be found in a system for detecting data. The system may include a computational device, a server and at least one analyst device. The computational device may include software instructions for searching locations on a network for data, testing the data and alerting or communicating with a server. The server may communicate with the computational device and provide software instructions and parameters. In addition, the server may store information associated with the testing or hidden data. The analyst device may communicate with the server to further analyze hidden messages or alert a user of data possibly containing hidden data. The server may also transfer parameters to the computational device such as those associated with alerts, testing methods, locations on the networks, among others. The server may receive an alert message associated with data from the computational device and communicate that alert message to the analyst device. The server may communicate using application layer transfer protocols such as HTTP, FTP, and SMTP, among others. The server may also provide software instructions to the computational device comprising interpreted language instruction files such as those in JAVA.

Additional aspects of the invention may be found in a computational device. The computational device may include software instructions for searching at least one location on the network for data, instructions for testing the data for hidden messages and instructions for communicating with a server. The communications with the server may include downloading program software instructions, parameters, and alerting the server or an analyst about the presence of indicators in a given data set.

As such, a system and method for distributed network monitoring for steganographic messages is described. Other aspects, advantages and novel features of the present invention will become apparent from the detailed description of the invention when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 is a schematic block diagram depicting the encoding and decoding of steganographic messages;

FIG. 2 is a schematic block diagram depicting a system, according to the invention;

FIG. 3 is a schematic block diagram depicting exemplary communication paths of the system as seen in FIG. 2;

FIG. 4 is a block diagram depicting an exemplary embodiment of a server, as seen in FIG. 2;

FIG. 5 is a block diagram depicting an exemplary embodiment of a client machine or device as seen in FIG. 2; and

FIG. 6 is a block flow diagram of an exemplary method for use by the system as seen in FIG. 2.

### DETAILED DESCRIPTION OF THE DRAWINGS

The growth of interconnected networks provides an increased amount of network traffic. In addition, the growth of the Internet has connected more computational devices of various types to a universally accessible network structure. With the rise of terrorism, more interest has been expressed in monitoring network traffic for hidden messages or steganographically-encoded data.

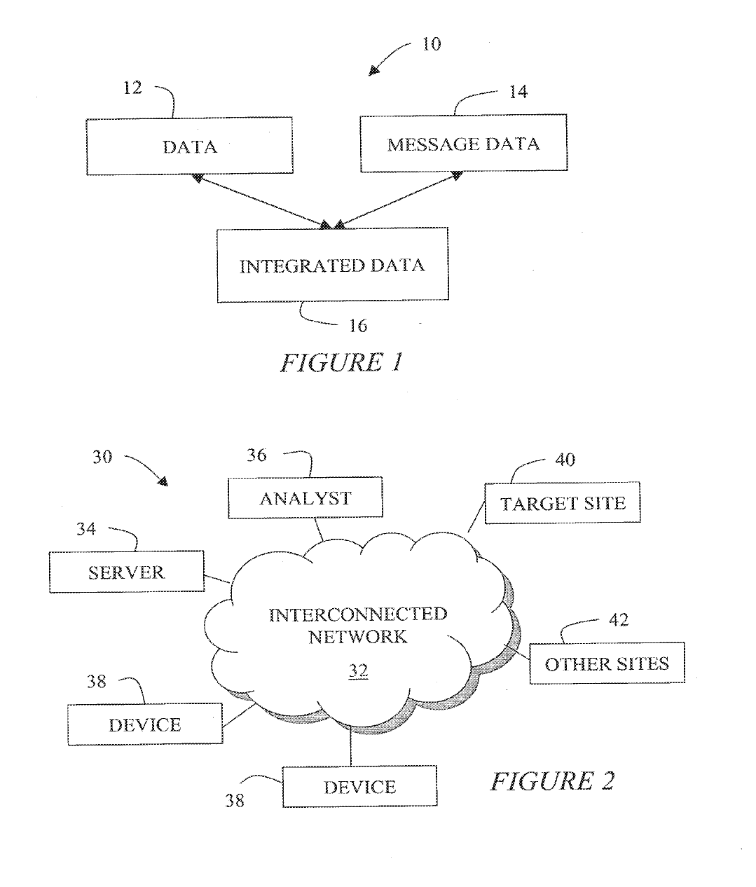

FIG. 1 depicts the encoding and decoding of data. Seemingly unimportant or innocuous data 12 may be combined with hidden message data 14 into an integrated data 16. The integrated data may carry with it many of the aesthetic aspects of data 12. However, with the correct key or method of decoding, the data 12 and the message data 14 may be recovered. If the exact method or key is not known, the integrated data 16 may still carry with it indications that a steganographic method or hidden message 14 is present.

Various steganographic programs and methods have been developed. For digital image and other data, various programs may be used to steganographically encode or decode data including Blindside, BMP Secrets, BMPEmbed, BMPTable, Camouflage 2.0, Contraband, Courier v1.0, Covert-TCP, Data Stash v1.1, DC-Stego, Diskhide, Dmagic v6.0, EIKONAmark, FFEncode, Giovanni (Bluespike), Hide4PGP, Invisible Encryption, Invisible Secrets Pro, MP3Stego, S-Tools, Snowdisk, Steganos, StegComm, SysCop, and White Noise Storm, among others. However, various programs, interfaces, and steganographic methods may be employed.

The integrated data 16 may carry with it indications that a steganographic message 14 is hidden within the data 16. In some cases, histograms, excessive noise, color palettes, and other parameters associated with image data may indicate the possibility presence of an encrypted message. However, in many cases, the exact encoding method must be known or many methods tested against the data.

As such, detection of steganographic messages in network traffic and distributed about a large public network may benefit from a large amount of computation cycles and network access points. Limitations on the available resources to law enforcement officials prevent widespread monitoring of network traffic and network locations. If the available cycles of various computers are used over a network and those computational devices are located in differing regions of the network, more network traffic and locations may be observed and tested. A distributed system of computers such as those in the homes of individuals may be used to provide the large amount of computational cycles and monitor various regions of the network.

FIG. 2 depicts an exemplary system 30 for monitoring network traffic and locations. Devices 38 may through the interconnected network 32 communicate with a server 34. The server may have programming instructions and parameters associated with target sites 40 and other sites 42. The programming instructions may be provided to the device 38 through the interconnected network 32. Then, the device 38 may interact with a target site 40 or other sites 42 to retrieve data. The data may be tested for the presence of hidden messages. If a hidden message or suspect data is found, the data or an alert regarding the location of the data may be sent from the device 38 through the interconnected network 32 to the server 34.

The analyst device 36 may communicate with the server 34 through the interconnected network 32. The analyst device 36 may request information regarding alerts and suspect data from the server 34. Alternately, the server 34 may send a message to the analyst device 36. Through the analyst device 36, an analyst may monitor the network 32.

The interconnected network 32 may take various forms and communicate using various protocols. These forms may include combinations of wireless networks, hard-wired networks, local area networks, wide area networks, global networks, among others. The networks may use protocols such as TCP/IP, and application layer protocols such as FTP, HTTP, and SMTP, among others. However, various networks and network protocols may be used in conjunction with the invention.

The computational devices 38 may take various forms. These forms may include desktop computers, notebook computers, handheld circuitries, smart phones, and other devices connected to the network and having available computational cycles. For example, a desktop computer may be connected to a network. The desktop computer may retrieve programming instructions and parameters from the server 34. These programming instructions and parameters may direct the computational device 38 to retrieve data from a specific target site 40 or other sites 42. The computational device 38 may then test the data for indications of hidden messages. Upon finding indications of hidden messages, the computational device 38 may alert analyst device 36. This may be performed by sending a message to the server 34 that subsequently is sent to or retrieved by the analyst device 36. However, the computational device 38 may alternately communicate directly with the analyst device 36.

The server 34 may take various forms. These forms may include servers coupled to an interconnected network 32 and running operating systems such as UNIX, LINUX, Windows NT, Windows 2000, a Mac OS, or various other operating systems, among others. The server may include instructions for accessing target sites, communicating with target sites, retrieving data from target sites, testing the data, and alerting or communicating with the server 34. In addition, the server may determine or store parameters associated with the location of target sites or a range of sites of interest. The server may also include parameters associated with testing methods and indicator thresholds. Further, the server may include parameters associated with the identity of an analyst or analyst device responsible for monitoring any given type of alert or alerts in general. For example, the server may send an email to an analyst device upon notification of suspect data. Alternately, the server may document the suspect data in a database accessible by the analyst device.

In one exemplary embodiment, the computational device 38 may be a laptop or desktop device having extra computational cycles such as computers in businesses, homes, and government facilities. The computational device 38 downloads interpretable instructions from the server 34. For example, the computational device 38 may use a web browser to interact with the server 34 and download a JAVA code. The server 34 may also provide parameters associated with a target site location or a range of other sites that may be searched. The JAVA code is interpreted by the device 38 to search the indicated sites for data, test the data for indications of hidden messages, and alert the server 34 of suspect data. This alert may be a posting or transfer of data to the server through FTP, HTTP, or other protocols. Alternately, the device 38 may send an email to the server 34 indicating the data or suspect data. The analyst device 36 may be a desktop or laptop computer which accesses the server to retrieve messages associated with suspect data. Alternately, the server 34 may send an email to the analyst device 36 notifying an analyst of suspect data. The email may or may not include the data or the location of the data.

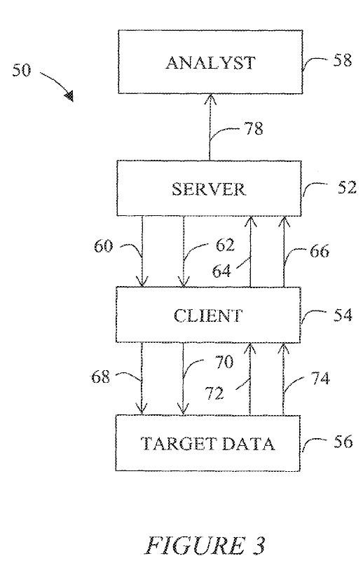

FIG. 3 is a schematic diagram depicting various communications between the components of the system. The server 52 may provide to the client 54 a communication 60 that includes a set of URL targets to be searched. Alternately, the server may distribute in a communication 62 a set of random IP address targets or a range of targets to be searched by the client 54. The client 54 may communicate with the target 56 with a message 68 which request website HTTP access. The client 54 may then scan for images and retrieve those images with a message 70. The target site 56 may provide a message indicating access to the client 72 and the requested images 74. The client 54 may then analyze the image data for hidden messages. If the data has a hidden message or has parameters indicative of the hidden message, the client 54 may communicate with a message 64 to a server 52 to indicate the presence of suspect data. The server 52 may then communicate in a message 78 to an analyst device 58 the presence of suspect data. If the client 54 exhausts sites in a search for data, the client 54 may request in a message 66 additional URL locations or a range of possible websites to search.

However, various other protocols may be used. In addition to HTTP, methods such as FTP and SNMP may be used to retrieve data, among others. Data such as sound data, image data, movie data, other compressed data, and text files, among others, may carry hidden messages and be tested by the client 54. Communications between the client 54, the server 52 and the analyst 58 may take various forms, including TCP/IP, SNMP, FTP, HTTP, and SMTP, among others.

In an exemplary embodiment, a server may distribute to a larger number of client devices programming instructions for testing data at various locations. The server may act to manage the locations that are tested and the alerts or messages associated with suspect data. In this manner, a large number of computational devices distributed about a public network may provide spare computational cycles to a centralized or set of centralized servers seeking to monitor a large amount of network traffic and locations.

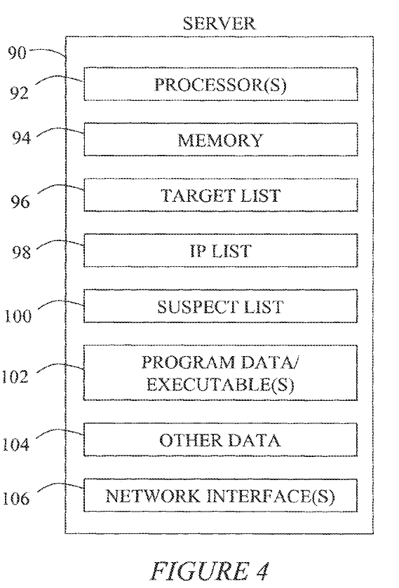

FIG. 4 is a block diagram depicting an exemplary server for use by the network as seen in FIG. 2. The server 90 includes a processor 92, memory 94, target list 96, IP list 98, suspect list 100, executable files 102, other data 104 and one or more network interfaces 106. However, each of these elements may or may not be included together, separate or in various combinations, among others.

Processor 92 and memory 94 may take various forms and interact to enable the delivery of information through the network interfaces 106 to analyst devices and computational devices. The processor or processors 92 may take various forms of computational circuitries. The memory 94 may include RAM, ROM, CD ROMs, DVDs, removable hard drives, hard drives, floppy drives and other storage mediums.

The server may also include a list of targets 96 and/or an IP address list 98. These lists may be used to distribute location data to client devices. These client devices then search the target or range of targets provided to find steganographically hidden messages. Once the suspect data is determined, the client device may provide information associated with the suspect data to the server, which may be stored as part of a suspect list 100.

The server 90 may also hold programmable data and executables 102. This data may comprise interpretable instruction files, executables, installation packages, testing method instructions, decoding instructions, and other programming instructions provided to client computational devices for use in seeking and testing network locations.

The server may also include various other data 104 and executables 102. The server may include operating systems, network interface instructions, communications protocols, among others. The other data 104 may include data associated with analysts, testing method threshold parameters, and original data files for comparison with suspect files.

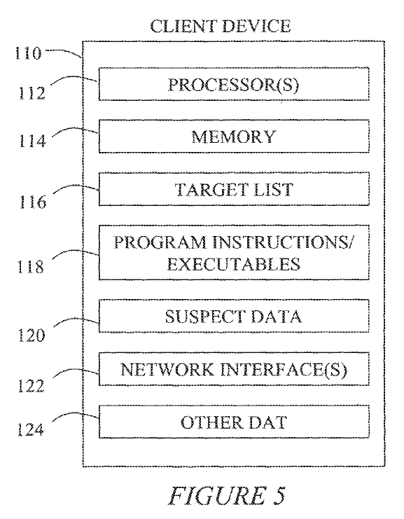

FIG. 5 is a block flow diagram depicting a client device 110. The client device 110 may include one or more processors 112, memory 114, IP/target data 116, executables 118, suspect data 120, network interfaces 122 and other data 124, among others. These elements may or may not be included together, separate or in various combinations, among others.

The processors 112 and the memory 114 may take various forms. The processor or processors 112 may take various forms of computational circuitries. The memory 114 may include RAM, ROM, CD ROMs, DVDs, removable hard drives, hard drives, floppy drives and other storage mediums.

The IP/target data 116 may be a list or range of addresses or locations located on the network for which the client device is responsible for searching. For example, this may include a list of IP addresses or domain names.

[The client device 110 may also include various executables 118 including operating systems, browsers and instructions for accessing the network interface. The executables and program instructions 118 may include software downloaded from the server containing instructions for searching locations on the network associated with the IP/target data 116, testing data located at those locations, and alerting or notifying the server of the presence of that data.

The client device may also include data downloaded from the target sites 120. The data is tested in accordance with the program instructions 118 to determine whether hidden messages exist or are indicated in the data. The client device may then store that data 120, forward to the server, or notify the server of the location of that data. The client device may also include other data 124 that takes the form of data for comparison with suspect data, testing parameters, and threshold values, among others.

Further, the client device may have one or more network interfaces 122 which permit and enable communication with the network through various protocols including HTTP, FTP, SMTP, TCP/IP, and SNMP, among others.

The server 90 of FIG. 4 and the client device 110 of FIG. 5 may work in conjunction to monitor network traffic and locations for suspicious data. The server may direct one or more computational devices to seek and test data associated with a specific IP address, domain name, newsgroup, chat room, message board, or website, among others; observe a specific data for change; or seek and test data in a address range; among others. For example, the server may direct a computational device to test messages on a specific message board for hidden messages found with a specific steganographic technique. In another example, the server may direct a computational device to observe a specific image data on a website and compare it with previous copies of the image data, testing the data for a change that would indicate the presence of a hidden message. Further examples include monitoring image postings in a newsgroup for suspicious images, seeking data in a range of IP addresses for data that appears suspicious given a specific testing technique, and downloading and testing data from a subscriber site for testing with a specified test, among others. However, various uses of the system may be envisioned.

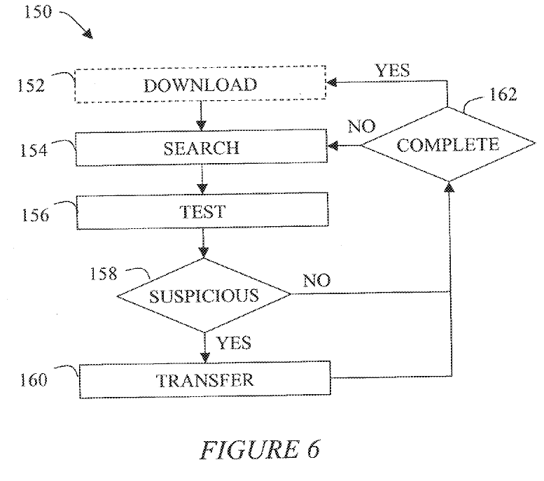

FIG. 6 depicts an exemplary method for monitoring a network for steganographic data. The method 150 includes searching the network, testing found data, and transferring alert messages to an analyst. Data, programs, and instructions may be downloaded to the client device as seen in a block 152. This data may provide the client device with the parameters of the search, information about the testing techniques, and information associated with alerting the analyst, among others.

As seen in a block 154, the client device may then seek and test suspect data in accordance with the instructions. This search may yield data that is then tested as seen in a block 156. The client device may test the data for indicators of hidden messages. The client device may use various testing, decode, and decrypting techniques, among others. The testing may also include comparing data with clean data; comparing parameters associated with the data with threshold values; and evaluating tables associated with the data, among others.

If the data is suspicious or possibly contains a hidden data or message, an alert may be forwarded to a server or analyst as seen in a box 160. This alert may include the data, information about the data, or the location of the data, among others. The alert may be an HTTP, FTP, or SMTP message. However, the alert may take various forms. The server may forward the information to an analyst or store the alert in a data file.

Once the data is tested, the client device may continue with the search over a given set of locations or may seek a new set. Alternately, the client may seek a new set of instructions, data, or programs, among others.

As such, a system and method for distributed network monitoring for steganographic messages is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims that follow.

What is claimed is:

1-31. (canceled)

32. A method for detecting suspected hidden subversive communications in media being communicated across a large public network, comprising the steps of:
monitoring media and communications on a large public network, comprising the steps of:
(a) operating a plurality of analyst devices in association with said large public network;
(b) directing said analyst devices to monitor media and communications data existing across said large public network;
(c) determining a presence and an origin of threshold data indicating suspected digital steganographically-encoded data, said suspected digital steganographically-encoded data potentially including hidden subversive communications, said digital steganographically-encoded data having been encoded using at least one yet to be determined digital steganography method for hiding subversive communications;
alerting selected ones of said analyst devices to said presence and said origin of said of threshold data and directing said selected ones of said analyst devices to further monitor said suspected digital steganographically-encoded data; and
alerting an authoritative entity to said suspected digital stegano-graphically-encoded data.

33. The method of claim 32, further comprising the step of operating said plurality of analyst devices at dispersed locations throughout said large public network.

34. The method of claim 33, further comprising the step of operating said plurality of analyst devices to search specified websites throughout said large public network.

35. The method of claim 32, further comprising the step of alerting an law enforcement entity to said suspected digital steganographically-encoded data.

36. The method of claim 32, further comprising the step of operating said plurality of analyst devices in association with said large public network using a plurality of different threshold detection processes for determining responses to different thresholds, thereby differently determining the presence of suspected steganographically-encoded data.

37. The method of claim 32, further comprising the step of operating said plurality of analyst devices in association with said large public network essentially simultaneously for determining the presence of various types of steganographically-encoded data.

38. The method of claim 32, further comprising the step of operating said plurality of analyst devices in association with said large public network for determining changing of said media and communications over time for determining the presence of hidden subversive messages.

39. The method of claim 32, further comprising the step of directing said analyst devices to monitor media and communications data existing across said large public network, wherein a substantial majority of said media and communications data contains no steganographically-encoded data.

40. A large public network monitoring system for detecting suspected hidden subversive communications in media being communicated across a large public network, comprising:
a plurality of computer processor workstations, said computer processor workstations operating under independent control and capable of transmitting media and communications data over a network;
a network for associating said plurality of computer process workstations and communication media and files across said network;
means for monitoring said media and communications on a large public network, comprising:
(a) a plurality of analyst devices operating in association with said large public network;
(b) instructions and circuitry for directing said analyst devices to monitor media and communications data existing across said large public network;
(c) instructions and circuitry for determining a presence and an origin of threshold data indicating suspected digital steganographically-encoded data, said suspected digital steganographically-encoded data potentially including hidden subversive communications, said digital steganographically-encoded data having been encoded using at least one yet to be determined digital steganography method for hiding subversive communications;
instructions and circuitry for alerting selected ones of said analyst devices to said presence and said origin of said of threshold data and directing said selected ones of said analyst devices to further monitor said suspected digital steganographically-encoded data; and
instructions and circuitry for alerting an authoritative entity to said suspected digital steganographically-encoded data.

41. The large public network monitoring system of claim 40, further comprising instructions and circuitry for operating said plurality of analyst devices at dispersed locations throughout said large public network.

42. The large public network monitoring system of claim 40, further comprising instructions and circuitry for operating said plurality of analyst devices to search specified websites throughout said large public network.

43. The large public network monitoring system of claim 40, further comprising instructions and circuitry for alerting an law enforcement entity to said suspected digital steganographically-encoded data.

44. The large public network monitoring system of claim 40, further comprising instructions and circuitry for operating said plurality of analyst devices in association with said large public network using a plurality of different threshold detection processes for determining responses to different thresholds, thereby differently determining the presence of suspected steganographically-encoded data.

45. The large public network monitoring system of claim 40, further comprising instructions and circuitry for operating said plurality of analyst devices in association with said large public network essentially simultaneously for determining the presence of various types of steganographically-encoded data.

46. The large public network monitoring system of claim 40, further comprising instructions and circuitry for operating said plurality of analyst devices in association with said large public network for determining changing of said media and communications over time for determining the presence of hidden subversive messages.

47. The large public network monitoring system of claim 40, further comprising instructions and circuitry for directing said analyst devices to monitor media and communications data existing across said large public network, wherein a substantial majority of said media and communications data contains no steganographically-encoded data.

48. A computer readable medium comprising instructions for controlling a large public network monitoring system for detecting suspected hidden subversive communications in media being communicated across a large public network, said computer readable medium comprising:
instructions for monitoring media and communications on a large public network, further comprising:
(a) instructions stored on said computer readable medium for operating a plurality of analyst devices in association with said large public network;
(b) instructions stored on said computer readable medium for directing said analyst devices to monitor media and communications data existing across said large public network;
(c) instructions stored on said computer readable medium for determining a presence and an origin of threshold data indicating suspected digital steganographically-encoded data, said suspected digital steganographically-encoded data potentially including hidden subversive communications, said digital steganographically-encoded data having been encoded using at least one yet to be determined digital steganography method for hiding subversive communications; and
instructions stored on said computer readable medium for alerting selected ones of said analyst devices to said presence and said origin of said of threshold data and directing said selected ones of said analyst devices to further monitor said suspected digital steganographically-encoded data.

49. The computer readable medium of claim 48, further comprising instructions stored on said computer readable medium for operating said plurality of analyst devices at dispersed locations throughout said large public network.

50. The computer readable medium of claim 48, further comprising instructions stored on said computer readable medium for operating said plurality of analyst devices to search specified websites throughout said large public network.

51. The computer readable medium of claim 48, further comprising instructions stored on said computer readable medium for alerting an law enforcement entity to said suspected digital steganographically-encoded data.

52. The computer readable medium of claim 48, further comprising instructions stored on said computer readable medium for operating said plurality of analyst devices in association with said large public network using a plurality of different threshold detection processes for determining responses to different thresholds, thereby differently determining the presence of suspected steganographically-encoded data.

53. The computer readable medium of claim 48, further comprising instructions stored on said computer readable medium for operating said plurality of analyst devices in association with said large public network essentially simultaneously for determining the presence of various types of steganographically-encoded data.

54. The computer readable medium of claim 48, further comprising instructions stored on said computer readable medium for operating said plurality of analyst devices in association with said large public network for determining changing of said media and communications over time for determining the presence of hidden subversive messages.

55. The computer readable medium of claim 48, further comprising instructions stored on said computer readable medium for directing said analyst devices to monitor media and communications data existing across said large public network, wherein a substantial majority of said media and communications data contains no steganographically-encoded data.
